(19) United States
(12) Patent Application Publication
(10) Pub. No.: US 2015/0198241 A1
(43) Pub. Date: Jul. 16, 2015

(54) Spool Valve

(71) Applicant: Caterpillar Inc., Peoria, IL (US)

(72) Inventors: Michael Barngrover, Brimfield, IL (US); Daniel G. Wear, East Peoria, IL (US)

(21) Appl. No.: 14/154,309

(22) Filed: Jan. 14, 2014

(51) Int. Cl. F16H 61/02; F16K 31/06; F16K 11/07

(52) U.S. Cl. CPC F16H 61/0251; F16K 11/07; F16H 61/0206; F16K 31/0613; F16H 2061/0253

(57) ABSTRACT

A spool valve is associated with a hydraulic system and includes a valve body delineating an inlet port, a relief port, and an actuator port. A spool is movably disposed inside the valve body between relief position, an opened position, and a modulating position. A solenoid can initially urge the spool from the relief position to the opened position to establish fluid communication between the inlet port and the actuator port. As a result, flow forces can further urge the spool to the opened position. When fluid communication between the inlet port and the actuator port ceases, the spool moves to a modulating position.

### TECHNICAL FIELD

This patent disclosure relates generally to hydraulic systems and, more particularly to a spool valve for selectively controlling fluid flow and pressure in a hydraulic system.

### BACKGROUND

Hydraulic systems are widely used to control and operate various kinds of machinery and mechanical devices. Hydraulic systems direct hydraulic fluid through a circuit and utilize the fluid power in the form of flow and pressure to selectively activate and deactivate various actuators such as hydraulic pistons, hydraulic motors and the like that run the machinery. Hydraulic systems may include a fluid reservoir or tank to accommodate the hydraulic fluid, a hydraulic pump to pressurize the fluid and force it to flow in the circuit, and various conduits, tubes and/or pipes to direct the fluid between the tank and the actuators. To selectively control the flow of hydraulic fluid in the circuit, the hydraulic system may also include a control valve that can change the direction of fluid flow.

One example of using hydraulics is to control a transmission disposed in a powertrain that couples a power source such as an internal combustion engine to a driven element such as wheels or a work implement. Transmissions include a plurality of gears that can be selectively engaged and disengaged to provide different gear ratios for increasing or decreasing the speed and, normally in an inverse relationship, the torque transmitted by the powertrain. To engage and disengage the gears, the hydraulic system can direct hydraulic fluid to and from actuators such as hydraulic clutches operatively associated with the gears of the transmission. Filling and relieving the clutches brings the gears into and out of engagement.

The control valves used in hydraulic systems that are operatively associated with transmissions are often embodied as spool valves. A spool valve can include a sleeve-like valve body with an axially disposed internal bore ending longitudinally along an axis and a plurality of ports radially disposed through the body to communicate with the internal bore. A spool that includes enlarged lands and undercut grooves is slidably disposed in the central bore. Sliding the spool along the axis of the internal bore selectively opens and seals the various ports so that fluid flow can occur in different directions through the spool valve.

One example of a spool valve for use in a hydraulic system associated with a powertrain is described in U.S. Pat. No. 5,911,245 (the '245 patent), assigned to the applicant of the present disclosure. The '245 patent describes a specific design for the spool valve in which the flow forces from the hydraulic fluid directed through the valve tend to cancel each other out when the spool is in a specific position. Accordingly, the spool can be maintained in that position with little or no effort. The present disclosure also addresses the beneficial manipulation of flow forces inside a spool valve.

### SUMMARY

The disclosure describes, in one aspect, a method of operating a hydraulic system using a spool valve to selectively establish fluid communication between a fluid source, an actuator, and a reservoir. According to the method, a spool is disposed inside a valve body of a spool valve and placed in a relief position to establish fluid communication between an actuator port in communication with an actuator and a relief port in communication with the reservoir. The method activates a solenoid mounted at a first body end of the valve body to initiate movement of the spool toward a second body end of the valve body to open an inlet port in fluid communication with a fluid source. Flow forces directed from the inlet port urge the spool fully toward the second body end and establish fluid communication between the inlet port and the actuator port. In response to fluid flow between the inlet port and the actuator port, the actuator is actuated. When the actuator is full, substantially all fluid flow between the inlet port and the actuator port ceases. Accordingly, the spool moves to a modulating position partly away from the second body end to modulate fluid communication between the inlet port, the actuator port, and the relief port.

In another aspect, the disclosure describes a spool valve having a valve body with a first body end and a second body end. The valve body delineates an internal bore and a plurality of ports communicating with the internal bore including an inlet port, a relief port, and an actuator port. A spool is slidably disposed in the internal bore and is movable between a plurality of positions including a relief position, an opened position, and a modulating position. A solenoid mounted to the valve body at the first body end is adapted to urge the spool toward the second body end to establish fluid communication between the inlet port and the actuator port while a spring member disposed in the internal bore proximate the second body end is adapted to urge the spool toward the first body end. Flow forces inside the spool valve caused by fluid communication between the inlet port and the actuator port urge the spool to the opened position.

In yet another aspect, the disclosure describes a method of shifting gears in a transmission operatively associated with a spool valve, a fluid source, and a reservoir. The method positions a spool disposed inside a spool valve so as to establish fluid communication between the transmission and the reservoir and block fluid communication between the fluid source and the transmission. The method also moves the spool to establish fluid communication into the spool valve by urging the spool with flow forces to an open position to establish fluid communication between the fluid source and the transmission. As a result, the method activates a clutch in the transmission. Thereafter, the method moves the spool valve to a modulating position to modulate fluid communication between the fluid source, the reservoir, and the transmission

### BRIEF DESCRIPTION OF THE DRAWINGS

FIG. 1 is a schematic illustration of a powertrain including a multispeed transmission connecting a power source such as an internal combustion engine to a driven element and a hydraulic system operatively associated with the transmission.

FIG. 2 is an example of a spool valve for the hydraulic system shown in cross-section with a valve body including an inlet port, an actuator port, and a relief port and the spool disposed in a closed position to block the inlet port with the fluid flow of the hydraulic fluid depicted by flow direction arrows.

FIG. 3 is the spool valve of FIG. 2 with the spool disposed in a fully opened position to establish fluid communication between the inlet port and the actuator port with the fluid flow of the hydraulic fluid depicted by flow direction arrows.

FIG. 4 is the spool valve with the spool disposed in a modulating position to modulate fluid communication between the inlet port, the outlet port, and the relief port with the fluid flow indicated by flow direction arrows.

FIG. 5 is a graph showing the flow forces in relation to spool displacement for a common spool valve as compared to a spool valve designed in accordance with the present disclosure.

FIG. 6 is a graph includes a series of line charts depicting variables associated with the spool valve such as fluid flow, fluid pressure, valve position, and solenoid current.

FIG. 7 is a block diagram of a flowchart depicting the various steps of operating a spool valve in accordance with the disclosure.

### DETAILED DESCRIPTION

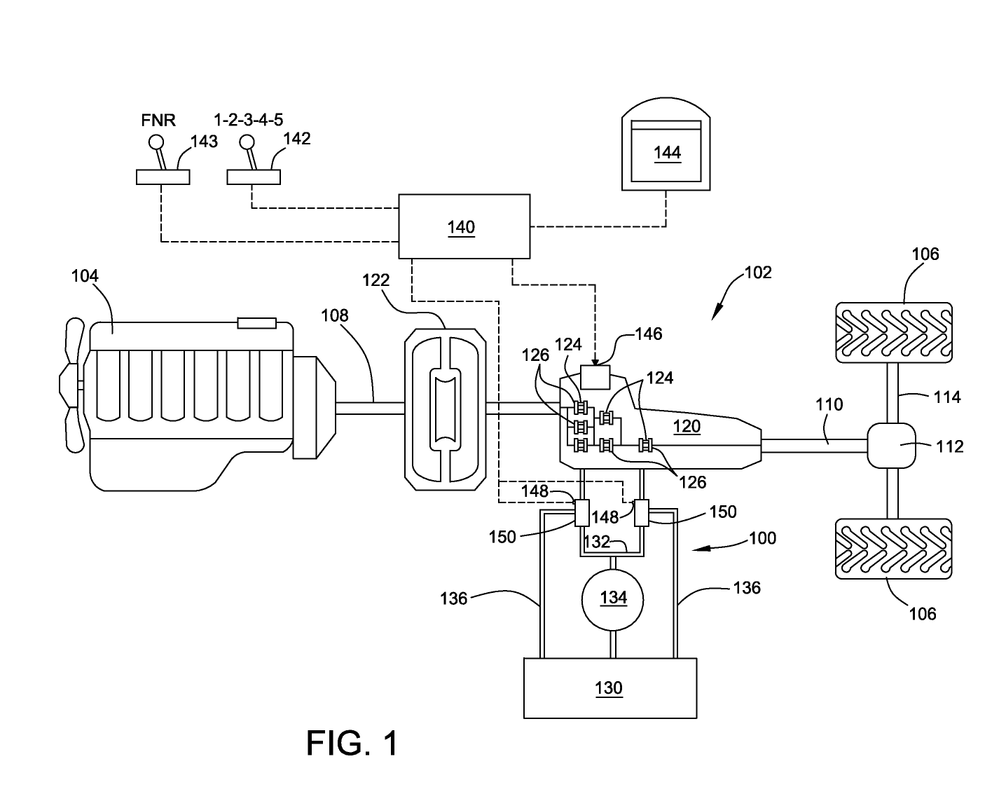

This disclosure relates to a control valve and, in particular, a spool valve for controlling fluid flow in a hydraulic system. Referring to FIG. 1, wherein like reference numbers refer to like elements, the hydraulic system 100 is shown in operative association with the powertrain 102 of a machine. The machine may be any type of machine that performs some operation associated with an industry such as mining, construction, farming, transportation, or any other industry known in the art. Examples of such machines include but are not limited to wheel loaders, bulldozers, excavators, back hoes, compactors, pavers, etc. Moreover, an implement may be connected to the machine. Such implements can be utilized for a variety of tasks, including, for example, loading, dozing, compacting, lifting, brushing, and include, for example, buckets, compactors, fork lifting devices, brushes, grapples, cutters, shears, blades, breakers/hammers, augers, and others. However, the hydraulic system in accordance with the disclosure is not limited to any particular machine and can be used in any appropriate environment.

The powertrain 102 can be used to connect and transmit power from a power source, such as an internal combustion engine 104, to one or more driven elements 106 such as wheels. In an embodiment, the internal combustion engine 104 can be a compression ignition diesel engine that burns a hydrocarbon based fuel to convert the chemical energy therein to mechanical power that may be used for other work. However, in other embodiments, other suitable types of power sources can include spark-ignition gasoline engines, turbines, hybrid engines, solar engines, and the like. The internal combustion engine 104 produces and outputs power in the form of rotational motion applied to a crankshaft 108 protruding from the engine. The rotational motion of the crankshaft 108 can be transmitted by the powertrain to a driveshaft 110 coupled to a differential 112. The differential 112 can redirect the rotational power to an axle 114 connected to the driven element 106 and thereby rotate the driven element.

As known to those of skill in the art, the speed and torque output of an internal combustion engine is determined by the amount and rate that fuel is combusted, which in turn may be constrained by the physical limitations of the engine. Furthermore, engines typically rotate the crankshaft in one direction that could place a corresponding limitation on the movement of the driven elements. Accordingly, to adjust the speed and torque output and the rotational direction of the internal combustion engine 104, the powertrain 102 can include a transmission 120 disposed between the engine and the driven elements. To selectively couple and uncouple the transmission 120 with the rotating crankshaft 108, a mechanical clutch or hydraulic device like a torque convertor 122 can be disposed in the powertrain 102 between the engine and the transmission.

By way of example, the transmission 120 can be a multispeed transmission that includes a plurality of selectively engageable friction elements, which, in the illustrated embodiment, can be series of interacting gears 124. Further, the transmission can be automatic or manual. The plurality of gears 124 can be arranged in predetermined pairs or groups so that when engaged, cause the transmission 120 to produce a specific gear ratio that is dependent upon the size and number of teeth of the selected gears. The gear ratio is directly related to the speed ratio of the transmission 120 that defines the increase or decrease in rotational speed between the crankshaft 108 and the driveshaft 110 that may be associated with the transmission output. The gear ratio or speed ratio can also define, in an inverse relationship, the change in output torque caused by the transmission. The transmission 120 can include any suitable number of predefined, selectable gear ratios. Further, the transmission 120 can also include a gear combination that reverses the rotational direction of the crankshaft 108 input from the engine 104. The selective change between gear ratios is sometimes referred to as shifting gears.

In an embodiment, the transmission 120 can be a synchronous transmission wherein the gear combinations that make up the predetermined gear ratios are continuously meshed together and one or more clutches are used to bring selected gear ratios into and out of fixed engagement with rotating shafts in the transmission that couple the crankshaft 108 and the driveshaft 110. Accordingly, in the illustrated embodiment, the plurality of gears 124 that make up the gear ratios can be operatively associated with a plurality of clutches 126. The plurality of clutches 126 can be hydraulic clutches that are engaged or released by controlling pressure of a hydraulic fluid supplied to the respective clutch, although in other embodiments the clutches may be activated by other technologies such as electromagnetic forces. When shifting up or down gear ratios, one set of clutches is pressurized to engage an unengaged gear ratio while a second set of clutches is simultaneously depressurized to disengage an engaged gear ratio. The first set may be referred to as the on-coming clutches and the second set may be referred to as the off-going clutches.

To supply hydraulic fluid to the plurality of clutches 126 in the illustrated embodiment, the powertrain 102 can be operatively associated with the hydraulic system 100 that includes a tank or refillable reservoir 130 for containing the hydraulic fluid and a plurality of interconnecting pipes or conduits 132 for fluid communication of the hydraulic fluid to and from the transmission 120. To pressurize and direct the hydraulic fluid in the hydraulic system, a fluid source such as a hydraulic pump 134 that can also be disposed in communication with the reservoir 130 and conduits 132. To control the actual flow of hydraulic fluid to and from the plurality of clutches 126 and relatedly the fluid pressure in the clutches, one or more flow-control pressure regulator valves such as a spool valve 150 can be disposed in the conduits 132 of the hydraulic system 130. Directional control valves, as is known to those of skill in the art, are used to switch the direction of fluid flow along different paths to and from sources and actuators so as to control the operation of a hydraulic system. As shown in FIG. 1, the directional control valves in the form of spool valves 150 can interconnect and establish fluid communication between the pump 134, the transmission 120, and back to the reservoir 130 by way of a return line 136. Although in FIG. 1 only two spool valves 150 are illustrated, other embodiments can have any suitable number of spool valves including one valve for each of the plurality of clutches 126. The spool valves may be separate from the transmission or disposed inside the transmission. In addition, while the same reservoir 130 is depicted as supplying hydraulic fluid to and receiving fluid from the transmission 120, in other embodiments this can be accomplished using different reservoirs.

To coordinate and control the various components of the powertrain including the hydraulic system 100, the powertrain can be associated with various sensors and controls that are regulated by an electronic or computerized controller 140. The controller 140 may be adapted to monitor various operating parameters and to responsively regulate various variables and functions affecting the powertrain. The controller 140 may include a microprocessor, an application specific integrated circuit (ASIC), or other appropriate circuitry and may have memory or other data storage capabilities. Although in FIG. 1, the controller 140 is illustrated as a single, discrete unit, in other embodiments, the controller and its functions may be distributed among a plurality of distinct and separate components.

To shift gears in the transmission 120, the controller 140 can be in communication with a gear selector 142 such as a gear stick that can be located in an operators cab on the machine or located off board of the machine for remote control. An operator can manipulate the gear selector 142 to direct a shift in gear ratios that can be communicated as an electrical or digital signal to the controller 140. The controller 140 can also be operatively associated with a forward-neutral-reverse (F-N-R) selector 143 that can place the transmission 120 in neutral and/or engage gear ratios in the transmission that reverse the rotational output of the internal combustion engine 104. In addition, the controller 140 can be associated with an operator display panel 144 such as an LCD screen or the like that can display information to and interface with an operator. To monitor and control the settings in the transmission 120, including sending directions to shift gear ratios, the controller 140 can be in communication with a transmission control 146 operatively associated with the transmission. The controller 140 can also communicate with one or more valve controls 148 that control operation of the spool valves 150 to change the configuration of the hydraulic system 100 with respect to the transmission 120.

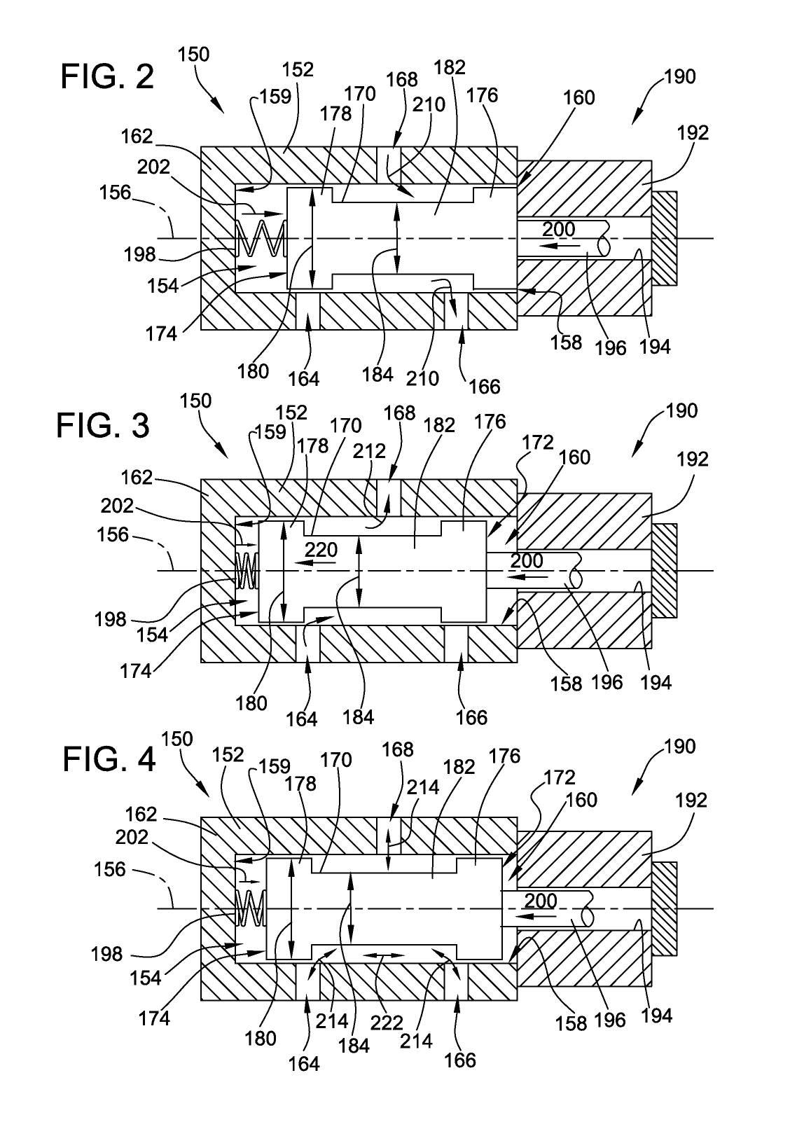

Referring to FIG. 2, there is illustrated in cross-section a spool valve 150 of the type that may be used with the hydraulic system of the present disclosure. In the illustrated embodiment, the spool valve 150 includes an elongated, hollow valve body 152 that delineates an internal bore 154 that can extend along a longitudinal axis 156 from a first body end 158 to an opposing second body end 159 of the valve body. The valve body 152 can be made from machined cast metal or a similar material. The internal bore 154 disposed in the valve body 152 can be cylindrical in cross-section or have any other suitable shape. Moreover, the internal bore 154 can be axially disposed completely through the valve body 152 at the first body end 158 so as to form an opening 160 to access the internal bore. At the second body end 159, the valve body 152 can form an end wall 162 that closes off the internal bore 154 at the second body end.

To connect the spool valve 150 to the rest of the hydraulic system, one or more fluid ports can be disposed through the valve body 152 including, in the illustrated embodiment, an inlet port 164, a relief port 166, and an actuator port 168. The inlet port 164, relief port 166, and actuator port 168 can be arranged radially in the valve body 152 with respect to the longitudinal axis 156. Moreover, the ports can be threaded or configured with suitable accommodations to receive hydraulic fittings or the like. The ports can be axially spaced apart from each other with the inlet port 164 axially offset toward the second body end 159 and the relief port 166 axially offset toward to the first body end 158. The actuator port 168 can be disposed approximately midway along the longitudinal axis 156 of the valve body 152 between the inlet and relief ports 164, 166. When connected to the hydraulic system shown in FIG. 1, the inlet port 164 can communicate with the pump 134, the relief port 166 can communicate with the reservoir 130 by way of the return line 136, and the actuator port 168 can communicate with the plurality of clutches 126 disposed in the transmission 120. While the illustrated embodiment of the spool valve 150 includes the three ports shown, in other embodiments, the spool valve can include any other suitable number of ports.

To selectively open and close the ports and establish fluid communication across the spool valve 150, a spool 170 can be moveably disposed in the internal bore 152. The spool 170 can be shorter in length than the internal bore 152 and can extend between a first axial spool face 172 and a second axial spool face 174 each of which are generally perpendicular to the longitudinal axis 156. In the illustrated embodiment, the spool 170 can have a shape similar to a barbell and can include an enlarged first valve land 176 adjacent the first axial spool face 172 and an enlarged second valve land 178 adjacent the second axial spool face 174. The first and second valve lands 176, 178 can have a spool diameter 180 that generally corresponds to the internal diameter of the internal bore 152 and can form a sliding fit within the internal bore. The spool 170 can also include a spool spine 182 formed as a undercut with a narrower spine diameter 184 that interconnects the first valve land 176 and the opposing second valve land 178. In various embodiments, the spool spine may have shapes other than cylindrical like the illustrated valve lands. The first and second valve lands 176, 178 may have a width greater than the diameter of the ports radially disposed in the valve body 152. Accordingly, as the spool 170 slides axially along the longitudinal axis 156 in the internal bore 152, the first and second valve lands 176, 178 can align with the different ports to block and seal them closed while moving out of alignment with other ports to open them. In an embodiment, the spool 170 can be made by machining a piece of metal in a turning operation or the like.

To move the spool 170 within the internal bore 154, the spool valve 150 can be operatively associated with a solenoid 190. A solenoid 190 is an electro-magnetic device that can include a coil 192 made of wire windings wrapped around a central tube 194. Moveably disposed in the central tube 194 can be a rod-like plunger 196 that can be made of a ferric, ferrous, or similar iron-containing material so that the plunger is responsive to a magnetic field. When an electric current is applied to the coil 192, the current generates a magnetic field that causes the plunger 196 to move into or out of the central tube 194. Accordingly, the plunger 196 can extend from or be retracted into the coil 192 by switching the electric current on or off. The solenoid can be configured to extend or retract the plunger when current is applied. In the illustrated spool valve 150, the solenoid 190 can be mounted to the first body end 158 of the valve body 152 proximate the opening 160 so that the plunger 196 can extend and retract through the opening. Moreover, the solenoid 190 can be mounted to the valve body 152 so that the plunger 196 is aligned with the longitudinal axis 156 and can contact the first axial spool face 172 of the spool 170 to apply a solenoid force 200 in the direction indicated to move the spool axially in the internal bore 154.

The spool valve 150 can also include a spring member 198 that operates in conjunction with and in response to the solenoid 190 to move and position the spool 170. The spring member 198 can be disposed at the second body end 159 between the end wall 162 and the second axial spool face 174 of the spool. The spring member 198 can be configured to apply a spring force 202 along the longitudinal axis 156 to oppose the solenoid force 200 generated by the solenoid 190. Accordingly, when the spool 170 moves toward the second body end 159 and compresses the spring member 198, the spring member will urge back against and oppose operation of the solenoid 190. Moreover, if electric current to the solenoid is cutoff, the spring member 198 can urge the plunger 196 back into the central tube 194 thereby moving the spool 170 toward the first body end 158. The spring member 198 can be any suitable type of spring such as a helical spring, a wave spring, and the like.

FIGS. 2, 3, and 4 show the spool valve 150 with the spool 170 at different positions as determined by the interoperation of the solenoid 190 and spring member 198. FIG. 2 shows the spool valve 150 in a closed position or a relief position which, in an embodiment, can correspond to the electric current and power being cut to the solenoid 190. In this state, the spring member 198 can urge the spool 170 axially toward the first body end 158 of the valve body 152 forcing the plunger 196 back into the coil 192. In an embodiment, the spool 170 can be moved so that the first valve land 176 is adjacent to and abuts the solenoid 190. When the spool 170 is in the closed or relief position, the second valve land 178 is aligned with and seals closed the inlet port 164 while the relief port 166 and the actuator port 168 remain open and are in fluid communication with each other. Hydraulic fluid can flow through the spool valve from the actuator port 168 around the spool spine 182 to the relief port 166 in the direction indicated by the flow direction arrows 210. For example, the actuator communicating with the actuator port 168 may be at a higher pressure than the reservoir connected to the relief port 166 to cause hydraulic fluid to flow in the appropriate direction. If the actuator is a clutch, the closed position of the spool valve 150 will drain the hydraulic fluid from the clutch and disengage the associated gear ratio.

To fill and pressurize a clutch with hydraulic fluid, for example, in order to engage a specific gear ratio, the spool valve 150 can be configured to the fully opened position shown in FIG. 3 that can correspond to electrical activation of the solenoid 190 and extension of the plunger 196. In response to extension of the plunger 196, the spool 170 can move toward the second body end 159 with the second axial spool face 174 compressing the spring member 198 against the end wall 162. The second valve land 178 moves away from and opens the inlet port 164 while the first valve land 176 simultaneously moves over and blocks closed the relief port 166. Hydraulic fluid under pressure from the pump associated with the hydraulic system can be at a higher pressure than associated with the actuator communicating with the actuator port 168. Accordingly, pressurized hydraulic fluid can enter the valve body 152 through the inlet port 164 and flow around the spool spine 182 to the actuator port 168 so that fluid communication is accordingly established between the inlet port 164 and the actuator port 168 as indicated by the flow direction arrows 212. The pressurized hydraulic fluid can be directed to the actuator connected to the actuator port 168 that may be, for example, a clutch that fills with the fluid and can engage a gear ratio.

The spool valve 150 can assume a third configuration referred to as a modulating position illustrated in FIG. 4. In this position, the forces provided by the solenoid 190 and by the spring member 198 can be configured so that that spool 170 assumes an intermediate position along the longitudinal axis 156 within the internal bore 154. In the modulating position, the first valve land 176 can be partially aligned with the relief port 166. Accordingly, while the relief port 166 is partially blocked, fluid communication can still occur across the relief port and hydraulic fluid can be returned to the reservoir. Further, when the spool 170 is in the modulating position, the second valve land 178 is aligned to partially block the inlet port 164 so that, while not fully opened, the spool valve 150 can still receive some pressurized hydraulic fluid from the pump. Accordingly, the inlet port 164, relief port 166 and actuator port 168 are all simultaneously in fluid communication and the net fluid flow across the spool valve 150 and/or toward the actuator is substantially reduced. Fluid flow may stagnate in the spool valve 150 as indicated by flow direction arrows 214. Moreover, in the modulating position, fine adjustments can be made to the fluid flow across the valve by making small increases or decreases to the current supplied to the solenoid.

In an embodiment, the spool valve can be designed to facilitate movement of the spool to the opened position. For example, referring to FIG. 3, the spool valve 150 can be designed so that flow forces 220 associated with the flow of the hydraulic fluid into the internal bore 154 assists the solenoid 190 in moving the spool toward the second body end 159. The flow forces result from the impingement of pressurized hydraulic fluid through the inlet port 164 against the spool 170. The spool geometry and angles of the ports can align the flow forces resulting from the incoming hydraulic fluid with the longitudinal axis 156. The flow forces 220 can further be aligned in the direction of the solenoid force 200 and toward the second body end 159. The combined effect of the flow forces 220 with the solenoid force 200 quickly overcomes the opposing spring force 202 causing the spool 170 to promptly move to the fully opened position where the spool is displaced over to the second body end 159 in the valve body 152. In other words, the flow forces 220 force the spool completely toward the second body end 159 so that the inlet port 164 and the actuator port 168 are opened and the relief port 166 is blocked. The result is that all of the flow of hydraulic fluid occurs between the inlet port 164 and the actuator port 168 speeding activation of the actuator. Referring to FIG. 4, once the hydraulic fluid fills the actuator and the flow stagnates as indicated by the flow direction arrows 214, the flow forces may dissipate so that the spool can be maintained in the modulating position. At this point, the flow forces may dissipate and the feedback pressure forces 222 from the pressurized hydraulic fluid may develop that assists maintaining the spool 170 in the intermediate position.

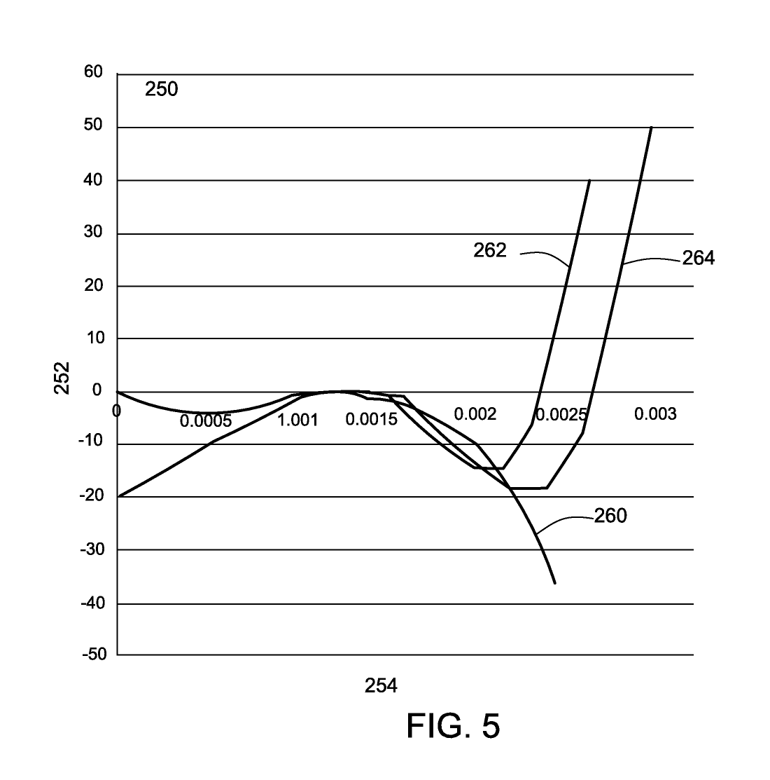

FIG. 5 graphically depicts the effect of combining the flow forces with the solenoid forces in the spool valve. The graph was determined by computer simulations and computational fluid dynamics models and compared to laboratory testing for similar valve configurations. The graph 250 in FIG. 5 represents the flow force 252 along the Y-axis with respect to spool displacement 254 to open the inlet port to the valve body along the X-axis. Positive flow force 252 along the Y-axis indicate the flow forces are assisting in moving the spool while negative flow forces resist movement of the spool. A first curve 260 depicts how the flow forces progress for the existing spool valves and indicates that flow forces 252 will begin to oppose spool displacement 254. The graph 250 also depicts a second curve 262 and a third curve 264 for a spool valve that aligns the flow forces with the solenoid force. As can be seen, the flow forces 252 assist in spool displacement 254 by speeding the time for displacement and/or by increasing the amount of displacement.

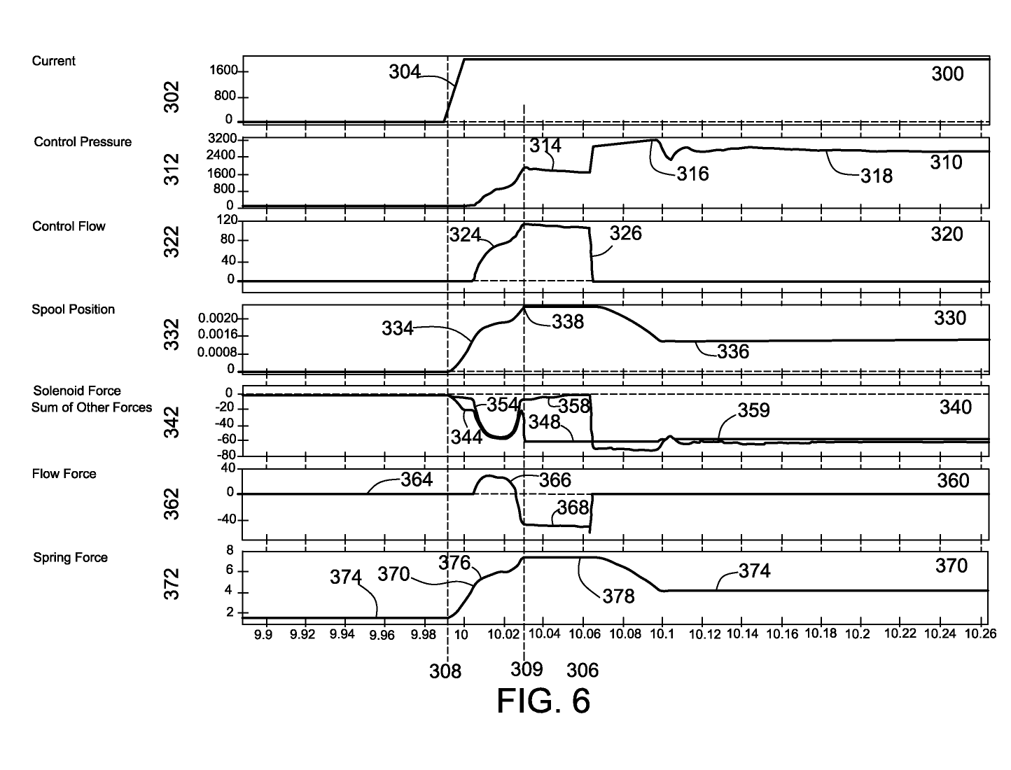

FIG. 6 is another graphical representation illustrating various operating parameters of a spool valve with respect to time when the flow forces from incoming hydraulic fluids are aligned with the solenoid forces. The data and information depicted in the line charts in FIG. 6 were obtained from computer simulations and/or computational fluid dynamics of a spool valve model. Accordingly, the examples described herein are prophetic.

The first line chart 300 at the top of the graph depicts application of the electric current 302 in, for example, milli-amperes to the solenoid represented along the Y-axis with respect to time 306 along the X-axis. The sharp increase in the current curve 304 at a first time instance 308 depicts when the solenoid is first activated to displace the spool from the closed position. The second line curve 310 depicts the fluid pressure 312 along the Y-axis in, for example, kPa of the hydraulic fluid directed from the inlet port through the spool valve into the actuator. As can be seen by the pressure curve 314, the fluid pressure 312 increases as the actuator fills with hydraulic fluid subsequent to the first time instance 308. Once the actuator is full, the fluid pressure 312 will generally rise to a max pressure 316 that can generally correspond to the system pressure supplied by the pump. The fluid pressure 312 thereafter may vary along a feedback pressure curve 318 that corresponds to system pressure and provides a feedback force against the solenoid forces. Filling of the actuator with hydraulic fluid is depicted in the third line chart 320 that represents the fluid flow 322 in, for example, liters per minute through the spool valve. When the solenoid is activated at the first time instance 308, the fluid flow 322 as represented by the flow curve 324 is directed through the spool valve into the actuator until the actuator is full. When the actuator is full, the fluid flow drops to zero as indicated by the decreased flow region 326 indicated in the flow curve 324. This corresponds to the modulating position of the spool valve depicted in FIG. 4. As indicated by the embodiment represented in FIG. 6, the fill time can be approximately 65 milliseconds. Based on the computer simulations run, it is believed that a fill time of 65 milliseconds may represent a reduction in time of about 15 milliseconds over prior art spool valves.

Referring to the fourth line chart 330, the spool displacement 332 corresponding to the fluid pressure 312 and fluid flow 322 shown above is represented along the Y-axis in, for example, meters. As can be seen by the position curve 334, initial displacement of the spool from the closed position blocking the inlet port begins when the solenoid is activated at a first time instance 308 and proceeds to a maximum displacement 338 at a later second time instance 309. The maximum displacement is achieved in approximately 0.04 seconds. When the actuator is full of hydraulic fluid, as indicated by the flow decrease 326 in the flow curve 324 of line chart 320, the spool moves away from the maximum displacement back to the modulating position 336 in the position curve 334 corresponding to an intermediate axial displacement of the spool valve.

The solenoid force, flow forces, and spring force responsible for displacing the valve are depicted in the fifth line chart 340, six line chart 360 and seventh line chart 370 respectively. The fifth line chart 340 shows the solenoid force 342 in, for example, Newtons along the Y-axis in an inverse relation as a result of plunger movement. The initial change in the solenoid force curve 344 corresponds to the first time instance 308 when the solenoid is activated. The solenoid force partially recovers then establishes a changed solenoid force 348 as indicated by the flat portion of the curve. The fifth line chart 340 also depicts another sum force curve 354 that represents the sum of other forces being applied to the spool valve. The sum force curve 354 generally follows the solenoid force curve 344 in the period subsequent to the first time instance 308. However, the sum force curve 354 recovers to a recovered sum force position 358 at the second time instance 309 as indicated while the solenoid force curve moves to the changed solenoid force 348. As seen by a comparison of the third, fourth and fifth line charts 320, 330, and 340, the recovered sum force position 358 corresponds to the filling of the actuator and full displacement of the spool. After the actuator has been filled, the sum forces move to a reduce sum force rate 359 as indicated.

The six line chart 360 depicts the flow forces 362 in, for example, Newtons that are generated in response to the flow of hydraulic fluid into the spool valve from the inlet port. In particular, the flow force curve 364 starts at zero because no hydraulic fluid is flowing through the valve to generate the flow forces. At the first time instance 308 when the solenoid is activated moving the spool valve from the relief position, the flow force curve 364 initially opposes spool movement as indicated by the resistance region 366. However, as the flow forces align to assist the solenoid, the flow force curve 364 enters an assistance region 368 resulting in the maximum spool position. The assistance region 368 corresponds to the filling of the actuator. The assistance region 368 is substantially larger than the resistance region 366 indicating that the overall sum of the flow forces assists movement of the spool. When the actuator is filled and flow of hydraulic fluids to actuator ceases, the flow force curve 364 again changes to zero.

The seventh line chart 370 represents the spring forces 372 in, for example, Newtons produced by the spring member. As indicated by the spring force curve 374, the spring force is initially low or at zero because the solenoid is inactivated and the spring member fully extended. At the first time instance 308 when the solenoid is activated initially moving the spool, the spring member becomes partially compressed creating a rising resistance region 376 in the spring force curve 374. When the flow forces in the flow force curve 364 enters the assistance region 368 indicating the flow forces assist spool movement at time 309 and the spool is at its max displacement 338, the spring force curve 374 reaches a maximum spring resistance 378. The maximum spring resistance 378 continues as the actuator fills with hydraulic fluid. Once the actuator is filled ceasing fluid flow and moving the corresponding flow force curve toward zero so that the spool is moved to the modulating position, the spring member partially extends so that the spring force curve 364 enters a modulating force region 369. At this point, the fluid pressure 312 along the feedback pressure curve 318 may be the dominate forces inside the spool valve.

### INDUSTRIAL APPLICABILITY

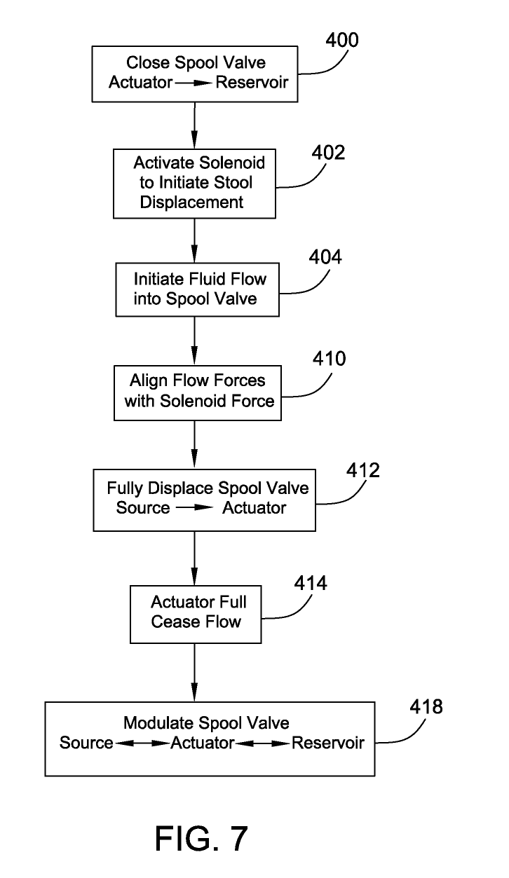

The spool valve designed in accordance with the present disclosure can be used to actuate an actuator such as a clutch in a transmission. Clutches typically require quick fill times so that the transmission shifts smoothly between gear ratios. The spool valve can assist in speeding fill times by realigning the flow forces through the spool valve to assist in displacing the spool. FIG. 7 depicts the steps of a process that the spool valve conducts. In an initial closed step 400, the spool valve is in a closed position in which the spool valve establishes fluid communication between the actuator and the reservoir so that the fluid pressure in the actuator is relieved. To initiate the process, an activation step 402 is performed in which a solenoid is activated to begin displacement of a spool from the closed position to an opened position. As a result, the spool moves away from the inlet port, hydraulic fluid can begin to enter the spool valve in an initial flow step 404. The flow forces can initially resist further displacement of the spool in the spool valve.

However, in an alignment step 410, the flow of hydraulic fluid is directed so that flow forces are aligned with the solenoid force. By aligning the flow forces with the solenoid forces, the spool can be moved to a full displacement position 412 within the spool valve. In this position, the relief port may be closed and all fluid communication occurs between the inlet port and the actuator port. Accordingly, the fluid source such as the pump can quickly fill the actuator with hydraulic fluid to engage the associated gear ratio. However, once the actuator is filled, as indicated by the actuator full step 414, flow of hydraulic fluid through the spool valve ceases. Accordingly, the flow forces associated with the fluid flow also drop to approximately zero. At this time, the spring forces in the spring member may be sufficient to partially overcome the solenoid forces to move the spool away from the fully displaced position. Further, the spring forces and solenoid forces may be approximately equal so that the spool valve begins to modulate fluid flow between the inlet port, the actuator port, and the relief port so that substantially no net flow occurs across the spool valve. This condition is represented by the modulating step 418 with fluid flow moving equally between the source, actuator, and reservoir. In this condition, the feedback pressure forces from the hydraulic fluid may become dominant. The solenoid forces balance out with pressure and spring forces to move the spool to the intermediate position. Pressure inside of and thus engagement of the clutch can be finely controlled by small adjustments of the current to the solenoid that can make slight modulations to the flow of the hydraulic fluid in the valve. A spool valve in accordance with the present disclosure can therefore produce quick fill times and can enable precision control of the clutches in the transmission.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

I claim:

1. A method of operating a hydraulic system including spool valve selectively establishing fluid communication between a fluid source, an actuator, and a reservoir, the method comprising:
positioning a spool disposed inside a valve body of a spool valve in a relief position establishing fluid communication between an actuator port in fluid communication with an actuator and a relief port in fluid communication with a reservoir;
activating a solenoid mounted at a first body end of the valve body to initiate movement of the spool toward a second body end of the valve body to open an inlet port in fluid communication with a fluid source;
directing flow forces from the inlet port to urge the spool fully toward the second body end and establishing fluid communication between the inlet port and the actuator port;
actuating the actuator in response to fluid flow between the inlet port and the actuator port;
substantially ceasing fluid flow between the inlet port and the actuator port in response to actuating the actuator;
moving the spool disposed inside the valve body to a modulating position partly away from the second body end to modulate fluid communication between the inlet port, the actuator port, and the relief port.

2. The method of claim 1, wherein the spool closes the relief port when the spool is moved fully toward the second body end.

3. The method of claim 2, wherein a spring member disposed proximate the second end of the valve body urges the spool to the modulating position.

4. The method of claim 3, further including decreasing the flow forces in response to actuating the actuator.

5. The method of claim 4, further including increasing fluid pressure in the spool valve in response to actuating the actuator.

6. The method of claim 5, wherein the valve body delineates an internal bore disposed along a longitudinal axis and the spool is slidably disposed in the internal bore.

7. The method of claim 6, wherein the flow forces are generally directed toward the second body end.

8. The method of claim 7, wherein the inlet port is disposed toward the first body end and the relief port is disposed toward the second body end.

9. The method of claim 8, wherein the actuator is a clutch operatively associated with a transmission.

10. The method of claim 9, wherein the spool includes first valve land and a second valve land interconnected by a spool spine.

11. A spool valve comprising:
a valve body including a first body end and a second body end, the valve body delineating an internal bore a plurality of ports communicating with the internal bore including an inlet port, a relief port, and an actuator port;
a spool slideably disposed in the internal bore and movable between a plurality of positions including a relief position, an opened position, and a modulating position;
a solenoid mounted to the valve body at the first body end and adapted to urge the spool toward the second body end thereby establishing fluid communication between the inlet port and the actuator port;
a spring member disposed in the internal bore proximate the second body end and adapted to urge the spool toward the first body end;
wherein flow forces from fluid communication between the inlet port and the actuator port urge the spool to the opened position.

12. The spool valve of claim 11, wherein the spool blocks closed the relief port when in the opened position.

13. The spool valve of claim 12, wherein the spool blocks closed the inlet port and establishes fluid communication between the actuator port and the relief port when in the relief position.

14. The spool valve of claim 13, wherein the spool establishes fluid communication between the inlet port, the relief port, and the actuator port when in the modulating position.

15. The spool valve of claim 14, wherein the spool includes first valve land and a second valve land interconnected by a spool spine.

16. The spool valve of claim 15, wherein the internal bore delineates a longitudinal axis between the first body end and the second body end.

17. The spool valve of claim 16, wherein the inlet port is axially disposed toward the second body end and the relief port is axially disposed toward the first body end.

18. A method of shifting gears in a transmission operatively associated with a spool valve, a fluid source, and a reservoir, the method comprising:
positioning a spool disposed in a spool valve to establish fluid communication between the transmission and the reservoir and blocking fluid communication between the fluid source and the transmission;
moving the spool to establish fluid communication into the spool valve;
urging the spool with flow forces to an open position to establish fluid communication between the fluid source and the transmission;
activating a clutch in the transmission; and
moving the spool valve to a modulating position to modulate fluid communication between the fluid source, the reservoir, and the transmission.

19. The method of claim 18, further comprising blocking fluid communication between the transmission and reservoir when the spool is in the open position.

20. The method of claim 19, wherein fluid flow to the transmission ceases when the clutch is activated.
